(19) United States
(12) Patent Application Publication
(10) Pub. No.: US 2022/0245576 A1
(43) Pub. Date: Aug. 4, 2022

(54) ROUTE PLAN USING NON-HOMOGENOUS EQUIPMENT VIA OCEAN ROUTES

(71) Applicant: Walmart Apollo, LLC, Bentonville, AR (US)

(72) Inventors: Jing Huang, San Jose, CA (US); Aditya Arcot Srinivasan, Sunnyvale, CA (US); Minghui Liu, San Bruno, CA (US); Mingang Fu, Palo Alto, CA (US)

(73) Assignee: Walmart Apollo, LLC, Bentonville, AR (US)

(21) Appl. No.: 17/163,428

(22) Filed: Jan. 30, 2021

(51) Int. Cl. G06Q 10/08; G01C 21/34

(52) U.S. Cl. CPC G06Q 10/0832; G06Q 10/0833; G01C 21/3492; G01C 21/3415; G06Q 10/087

(57) ABSTRACT

A system including one or more processors and one or more non-transitory computer-readable media storing computing instructions configured to run on the one or more processors and perform: obtaining orders for fulfillment to physical stores from a distribution center, wherein the orders are associated with stacks comprising temperature-controlled pallets and non-temperature-controlled pallets; splitting the orders based on a type of each order; determining containers that are available for driver shifts, wherein the containers comprise temperature-controlled containers each having multiple compartments and dry containers each having a single compartment; generating potential routes by assigning, using a utilization-guided search, the non-temperature-controlled pallets and the temperature-controlled pallets to compartments of the containers; determining, from the potential routes, solution routes that are feasible and minimize costs; and outputting the solution routes. Other embodiments are disclosed.

### TECHNICAL FIELD

This disclosure relates generally relates to route and load plans using non-homogenous equipment via ocean routes.

### BACKGROUND

Conventionally, route and load plans for a container to carry orders via an ocean vessel can be a complex process and often based on manual input. Such processes can be time consuming due to the complexity of transporting a mix of dry goods and perishable goods in each container subject to delivery route plans.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatic generation of a route plan using non-homogenous equipment via ocean routes, according to an embodiment;

FIG. 4 illustrates a flow chart for a method, according to another embodiment;

FIG. 5 illustrates a flow chart for a method of automatic generation of a route and load plan using non-homogenous equipment via ocean routes, according to another embodiment;

FIG. 6 illustrates a flow chart for a method of automatic generation of a route and load plan using non-homogenous equipment via ocean routes, according to another embodiment; and

FIG. 7 illustrates a top plan view of exemplary semi-trailers and alternative bulkheads.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than 1 minute, 5 minutes, 10 minutes, or another suitable time delay period.

### DESCRIPTION OF EXAMPLES OF EMBODIMENTS

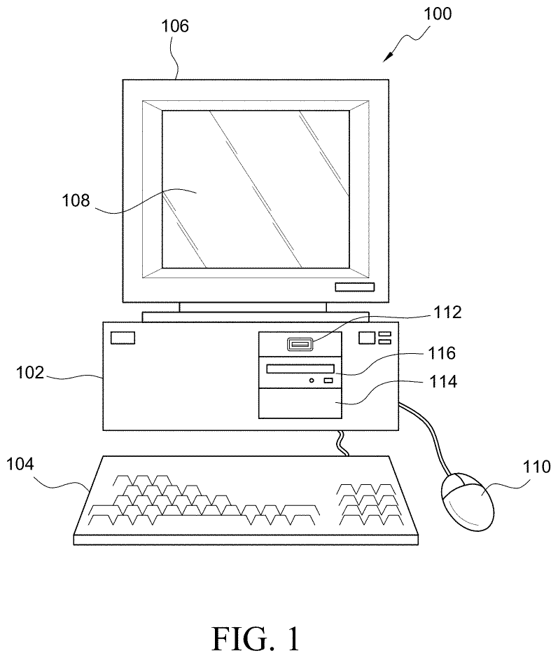

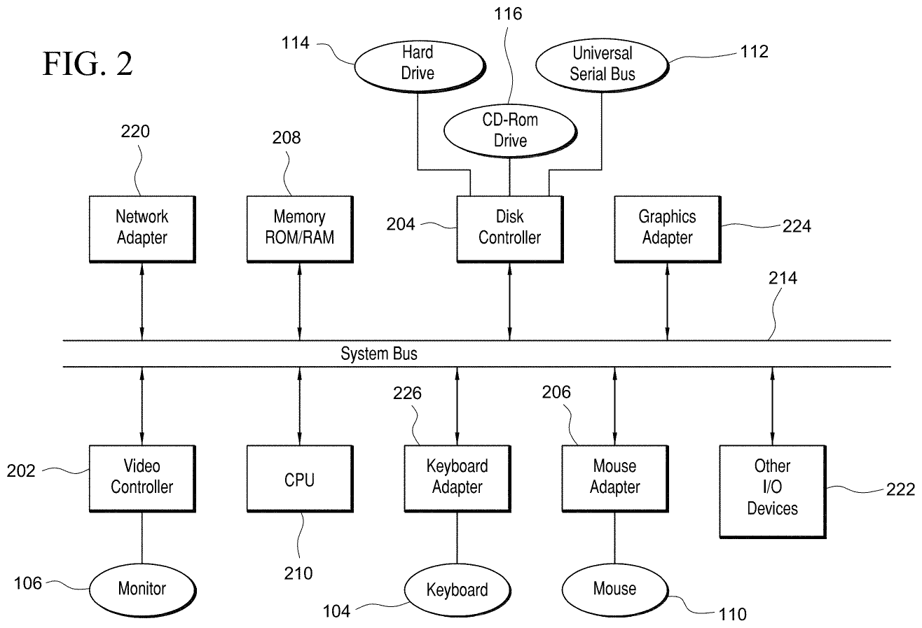

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIGS. 1-2). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

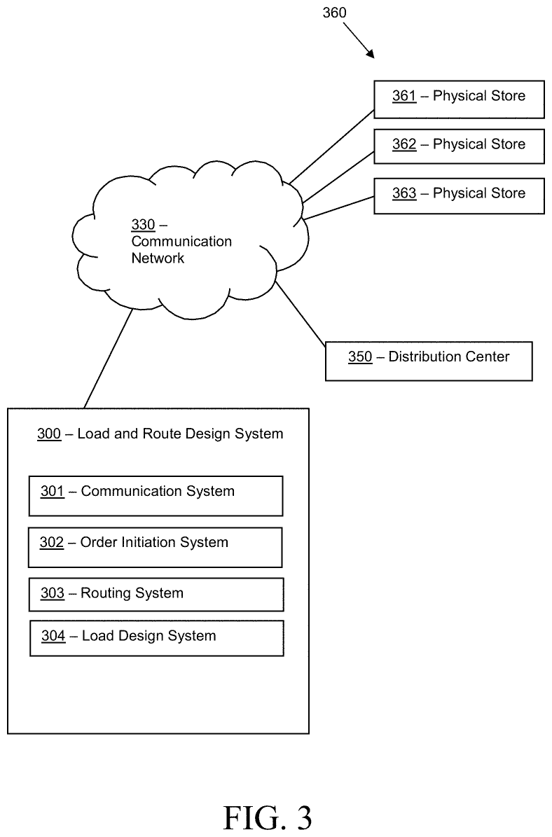

Turning ahead in the drawings, FIG. 3 illustrates a block diagram of a load and route design system 300 that can be employed for automatic generation of a load and route design for non-homogenous equipment via ocean routes, according to an embodiment. Load and route design system 300 is merely exemplary and embodiments of the system are not limited to the embodiments presented herein. Load and route design system 300 can be employed in many different embodiments or examples not specifically depicted or described herein. In some embodiments, certain elements, modules, or systems of load and route design system 300 can perform various procedures, processes, and/or activities. In other embodiments, the procedures, processes, and/or activities can be performed by other suitable elements, modules, or systems of load and route design system 300. Load and route design system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of load and route design system 300 described herein.

Load and route design system 300 can be a computer system, such as computer system 100 (FIG. 1), as described above, and can each be a single computer, a single server, or a cluster or collection of computers or servers, or a cloud of computers or servers.

In some embodiments, load and route design system 300 can be in data communication through a communication network 330 with physical stores 360, which can include physical stores 361-363, for example, and distribution centers, such as distribution center 350. In several embodiments, each of the physical stores (e.g., 360) and each of the distribution centers (e.g., 350) can be a physical, brick-and-mortar location that are associated (e.g., operated by a common business entity or entities under common control) with load and route design system 300. In many embodiments, the physical stores (e.g., 360) and the distribution centers (e.g., 350) each can include one or more computer systems.

In a number of embodiments, each of physical stores 360 can be a retail store, such as a department store, a grocery store, or a super store (e.g., both a grocery store and a department store). In many embodiments, the distribution centers (e.g., 350) can provide the items sold at the physical stores (e.g., 360). For example, a distribution center (e.g., 350) can supply and/or replenish stock at the physical stores (e.g., 360) that are in a region of the distribution center. In many embodiments, physical stores (e.g., 360) can submit an order to a distribution center (e.g., 350) to supply and/or replenish stock at the physical store (e.g., 361-363). In many embodiments, distribution center 350 can be referred to as a warehouse or other facility that does not sell products directly to a customer.

In some embodiments, load and route design system 300 can be a distributed system that includes one or more systems in each of the distribution centers (e.g., 350). In other embodiments, load and route design system 300 can be a centralized system that communicates with computer systems in the physical stores (e.g., 360) and distribution centers (e.g., 350). In some embodiments, communication network 330 can be an internal network that is not open to the public, which can be used for communications between load and route design system 300, physical stores (e.g., 360), and distribution centers (e.g., 350). In other embodiments, communication network 330 can be a public network, such as the Internet. In several embodiments, operators and/or administrators of load and route design system 300 can manage load and route design system 300, the processor(s) of load and route design system 300, and/or the memory storage unit(s) of load and route design system 300 using the input device(s) and/or display device(s) of load and route design system 300, or portions thereof in each case.

In several embodiments, load and route design system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to load and route design system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of load and route design system 300. In a similar manner, the processors and/or the non-transitory computer-readable media can be local and/or remote to each other.

Meanwhile, in many embodiments, load and route design system 300 also can be configured to communicate with and/or include one or more databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between load and route design system 300, communication network 330, physical stores 360, distribution center 350, and/or the one or more databases can be implemented using any suitable manner of wired and/or wireless communication. Accordingly, load and route design system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

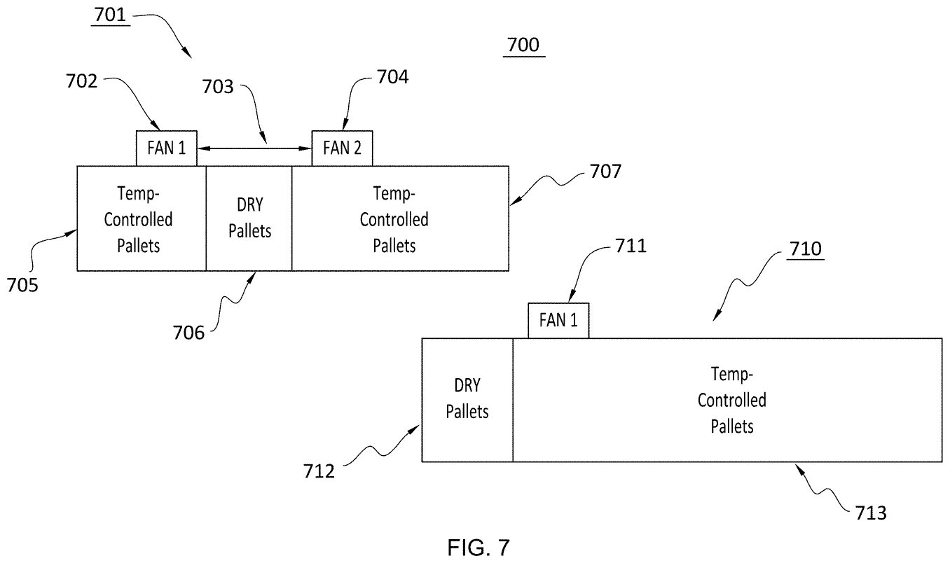

In several embodiments, load and route design system 300 can receive an order for a physical store (e.g., 361-363) and can automatically design a load and route plan for the order to be delivered to the physical store at an overseas destination. In some embodiments, the order can be transported to a destination via an ocean route prior to delivery at the physical store. In a number of embodiments, load and route design system 300 can determine the type of pallets to be used for items in the order, including temperature-controlled pallets, determine how to split stacks of the types of pallets to be shipped in non-homogenous trailers (e.g., a mix of non-temperature-controlled (i.e., “dry”) pallets and temperature-controlled pallets) and/or homogenous trailers (all pallets of one type), design and/or obtain routes to be used for the trailers, and/or design load placement within the trailers for these routes. In several embodiments, the trailers each can be any form of road haulage shipping container or compartment, such as a semi-trailer, a full trailer, etc. In various embodiments, the terms trailer and container can be used interchangeably. In some embodiments, the trailers can each be configured with non-homogenous equipment to transport temperature-controlled pallets and/or non-temperature-controlled pallets, such as removable bulkheads (e.g., alternative bulkheads), via ocean routes and/or land routes. For example, the trailers can be similar or identical to trailer 701 and/or trailer 710, as shown in FIG. 7 and described below.

In many embodiments, load and route design system 300 can include a communication system 301, an order initiation system 302, a routing system 303, and/or a load design system 304. In many embodiments, the systems of load and route design system 300 can be modules of computing instructions (e.g., software modules) stored at non-transitory computer readable media that operate on one or more processors. In other embodiments, the systems of load and route design system 300 can be implemented in hardware. Load and route design system 300 can be a computer system, such as computer system 100 (FIG. 1), as described above, and can be a single computer, a single server, or a cluster or collection of computers or servers, or a cloud of computers or servers. In another embodiment, a single computer system can host load and route design system 300. Additional details regarding load and route design system 300 and the components thereof are described herein.

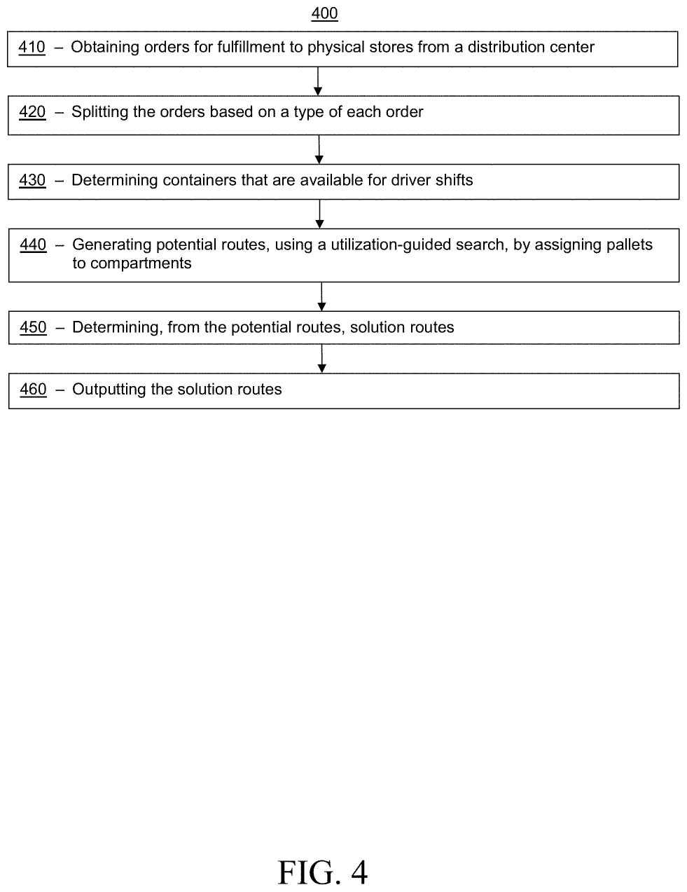

Turning ahead in the drawings, FIG. 4 illustrates a flow chart for a method 400, according to another embodiment. In some embodiments, method 400 can be a method of automatically generating a route and load plan using non-homogenous equipment via ocean routes. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, load and route design system 300 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as load and route design system 300 (FIG. 3). The processor(s) can be similar or identical to the processor(s) described above with respect to computer system 100 (FIG. 1).

In some embodiments, method 400 and other blocks in method 400 can include using a distributed network including distributed memory architecture to perform the associated activity. This distributed architecture can reduce the impact on the network and system resources to reduce congestion in bottlenecks while still allowing data to be accessible from a central location.

Referring to FIG. 4, method 400 can include a block 410 of obtaining orders for fulfillment to physical stores from a distribution center. The physical stores can be similar or identical to physical stores 360 (FIG. 3). The distribution center can be similar or identical to distribution center 350 (FIG. 3). In some embodiments, the orders can include dry (e.g., non-temperature-controlled) orders and perishable (e.g., temperature-controlled) orders. As an example, different types of items in an order can be determined in order to determine what categories of items are included in the order, such categories can include a dry order or a perishable order. The types of items (also referred to as “commodity types”) can include a perishable order of (a) “MP,” which can include meats and produce, which can involve temperature control; (b) “FDD,” which can include food, dairy, and deli, which can involve temperature control; and a dry order of (c) “dry,” which can include any other items that do not involve temperature control. As another example, the order can include a requested delivery date, which can be the day that the physical stores (e.g., 360 (FIG. 3)) requests to receive the shipment of the order at an overseas location.

In many embodiments, each of the types of items in the order can be stored in the distribution center (e.g., 350 (FIG. 3)) on separate types of pallets. Such separate types of pallets can be either the temperature-controlled pallets or the non-temperature-controlled pallets. For example, the order can include an order for one non-temperature-controlled pallet of a particular brand of flour, and two non-temperature-controlled pallets of a particular brand of sugar. In several embodiments, the collective pallets can be arranged into stacks at the distribution center (e.g., 350 (FIG. 3)) ready to be loaded into a dry container, a temperature-controlled container with removable bulkheads, and/or another suitable container and/or trailer. In various embodiments, each of the orders can be pre-processed in preparation for building one or more loading plans outbound for distribution centers.

In a number of embodiments, method 400 also can include a block 420 of splitting the orders based on a type of each order. In several embodiments, the orders can be pre-processed, beginning with splitting the dry orders and the perishable orders. In some embodiments, the orders can be associated with stacks including the temperature-controlled pallets and the non-temperature-controlled pallets. Pallets can be stacked to create a stack. A stack can be a stack of one or more pallets from bottom to top. A number of constraints can apply when building stacks from pallets by splitting the orders based on a type of each order. For example, the inside height of the trailer can limit the height of stacks, which can impose a stack height limit. If the inside height of a trailer is approximately 111 inches, there can be a stack height limit of approximately 108 inches, for example, for that particular trailer. Depending on the stack height limit and the height of the individual pallets a stack can include one pallet, two pallets, three pallets, or four or more pallets.

In several embodiments, splitting the orders can involve designing how the temperature-controlled pallets and the non-temperature-controlled pallets should be stacked into a customized (e.g., optimized) arrangement based on temperature constraints. In some embodiments, the customized arrangement can limit the amount of floor spots in each compartment that can be used in the container when the stacks are shipped via an ocean route and delivered to physical stores (e.g., 360 (FIG. 3)) at an arrival destination. For example, a pallet that includes items at a certain temperature range (e.g., frozen, refrigerated, dry (non-refrigerated)) can be stacked with other pallets that include items at the same temperature range, and not with pallets that include items at other temperature ranges. As another example, the orders can be split by a type of category, dry orders or perishable orders, as perishable orders can be loaded into the temperature-controlled trailers and/or temperature-controller compartments (e.g., separated by bulkheads) within the trailers for transport. In some embodiments, the orders can be partitioned into the different distribution centers (e.g., 350 (FIG. 3)) to be used to fulfill the orders.

In many embodiments, block 420 can include splitting the dry orders into a configurable size subject to satisfying one or more order splitting constraints. In several embodiments, splitting a dry order can include splitting the dry order into chunks subject to two constraints: a connected components constraint and a minimum sub-order size constraint. In various embodiments, pre-processing the orders can include sorting the dry orders first before sorting the perishable orders. In several embodiments, dry orders and perishable orders for a same physical store can be optimally arranged together for transport using a same container based on a route plan. For example, a route plan can include sequential stops at a destination location, such as a route plan can include an Anchorage store, then a Fairbanks store, then a Kenai store, then a Kodiak store.

In some embodiments, block 420 can include constructing a first graph of connected components of the dry orders. In several embodiments, block 420 can include performing a depth first search of the first graph using a traversal algorithm to determine connected components not to split the dry orders. In various embodiments, every split component of the dry order can be greater than the minimum size order for transport via an ocean route and delivery to physical stores 360 (FIG. 3) for each location at a destination port and/or a country. In various embodiments, a minimum sub-order size constraint can be a vendor constraint of a minimum amount of an item per order. In a number of embodiments, each split component of the dry order can obey a connected component rule. Such connected component rules can include a constraint, restriction, and/or prohibition that every split of each dry order contain stacks and pallets picked and processed as part of a same release.

In various embodiments, the connected component rule can be implemented by constructing the first graph of connected components of a dry order. In many embodiments, performing a depth first search based on a graph traversal algorithm can isolate out any connected components that cannot be split.

In several embodiments, block 420 can include splitting the perishable orders by temperature subject to satisfying the one or more order splitting constraints. In various embodiments, block 420 can include constructing a second graph of connected components of the perishable orders. In some embodiments, block 420 can include performing a depth first search of the second graph using a traversal algorithm to determine connected components not to split.

In various embodiments, block 420 can include sorting the orders for delivery based on the type of the orders and the physical stores to which the orders are associated.

In some embodiments, block 420 can include setting a max instance to zero for the temperature-controlled container. In several embodiments, block 420 can include calculating the max instances of the driver shifts using a floor spot capacity estimator. In various embodiments, calculating the max instances can include determining a maximum number of floor spots for the containers based on pallet dimensions, trailer dimensions, and bulkhead positions. In some embodiments, calculating the max instances can include setting the max instance to a ratio of a total number of the stacks to the maximum number of floor spots.

In various embodiments, each potential driver shift can be associated with a type of trailer. In many embodiments, many types of trailers can include the same physical dimensions and costs, however some types of trailer can have a removable bulkhead or fixed bulkheads with temperature-controlled compartments. In several embodiments, each potential driver shift can be based on selecting the type of trailer with a removable bulkhead. In several embodiments, a max instance of a trailer without a removable bulkhead corresponding to a potential shift can be set to 0 for the similar trailer types with available bulkhead options.

In some embodiments, the max instance of the corresponding trailer shift with the cost and dimensions but without the removable bulkhead is set to 0. In several embodiments, if the trailer with the removable (e.g., alternative bulkhead) is not selected for the optimal solution route, the trailer recommendation can be switched as the route and load is guaranteed to be feasible. In various embodiments, the max instances of all driver shifts can be calculated by a floor spot capacity estimator. For example, a floor spot capacity estimator can take into consideration, pallet dimensions, trailer dimensions, pallet orientation, bulkhead positions, and/or return a set of maximum possible floor spots for every type of trailer. In some embodiments, a maximum number of instances can be set to a total number of stacks for the maximum floor spots available in the trailer.

In a number of embodiments, method 400 additionally can include a block 430 of determining containers that are available for driver shifts. In various embodiments, the containers can include temperature-controlled containers each having multiple compartments and dry containers each having a single compartment. In some embodiments, when the containers (e.g., a trailer) is a bi-temp container and/or a tri-temp container, the floor spot assignments for the stacks can be determined based at least in part on a quantity of different temperature ranges associated with the one or more of the orders in the load. For example, when all of the stacks in the load are for a single temperature range (e.g., all frozen, or all refrigerated, or all dry), a load design can be treated the same as a “dry” trailer, as there is effectively a single compartment, even if there are multiple actual compartments, because each of the actual compartments will be at the same temperature range.

When there are two different temperature ranges for the stacks in the load, the stacks can be separated into the three compartments with a first group of the stacks for a first temperature range in one or two of the compartments, and a second group of the stacks (e.g., those remaining after removing the first portion) in the other one or two compartments. Both compartments can be set to the same temperature range for the group that is in two compartments. Generally, in a tri-temp trailer, the compartment with the largest possible capacity is smaller than the combined capacity of the second-largest and third-largest compartments. With these types of tri-temp trailers, as long as the number of stacks in the larger of the two groups of stacks fits within the combined capacity of the second-largest and third-largest compartments, the load design can satisfy compartment capacity constraints.

When there are three different temperature ranges for the stacks in the load, the stacks can be separated into the three compartments with a first group of the stacks for a first temperature range in one of the compartments, a second group of the stacks in a second one of the compartments, and a third group of the stacks in the remaining compartment. As long as the number of stacks in the largest of the three groups of stacks fits within the capacity of the largest compartment, the number of stacks in the second-largest of the three groups of stacks fits within the capacity of the second-largest compartment, and the number of stacks in the third-largest of the three groups of stacks fits within the capacity of the third-largest compartment, the load design can satisfy compartment capacity constraints. For a tri-temp trailer with one, two, or three different temperature ranges, the load also can be verified to satisfy the center-of-gravity constraints for the trailer.

In several embodiments, block 430 can include selecting a temperature-controlled container with a removable bulkhead for a driver shift of the driver shifts, wherein the driver shifts are each associated with a respective type of container.

In some embodiments, block 430 can include selecting an alternative dry container having a cost and physical dimensions that are identical to a cost and physical dimensions of the temperature-controlled container. In various embodiments, when a bulkhead of the temperature-controlled container is used in the solution routes, the temperature-controlled container with the removable bulkhead can be retained for the driver shift. In many embodiments, when the bulkhead of the temperature-controlled container is not used in the solution routes, the temperature-controlled container can be switched out for the dry container.

In various embodiments, method 400 can include a block 440 of generating potential routes by assigning, using a utilization-guided search, the non-temperature-controlled pallets and the temperature-controlled pallets to compartments of the containers. In some embodiments, a utilization-guided search for non-temperature-controlled pallet (e.g., dry pallet) assignments with consideration for splits can be used to book slots for orders for non-temperature-controlled pallets.

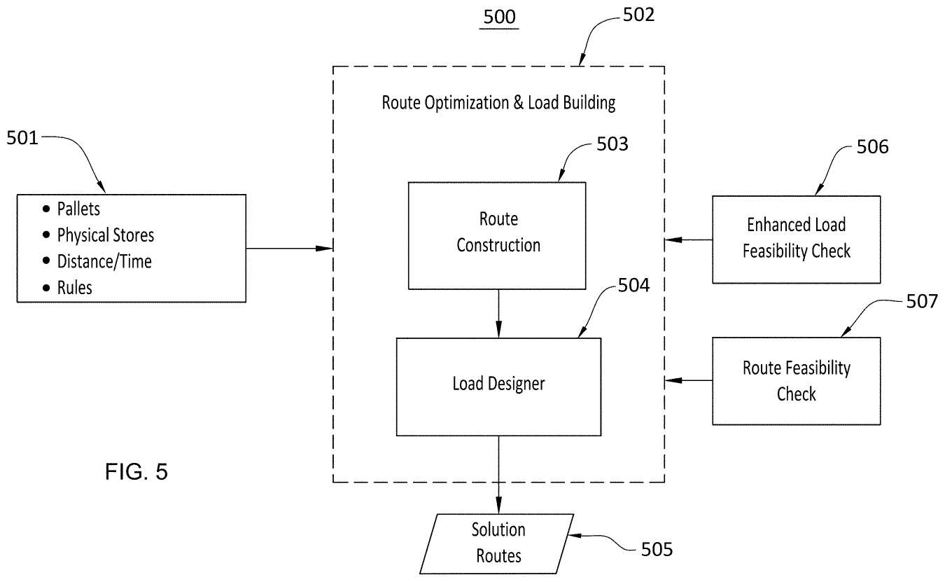

In several embodiments, booking slots (e.g., part of assigning the types of pallets in a container) can be handled using a greedy heuristic which is used in the following stages of load and route designs along with a combination of rules and heuristics. In some embodiments, a utilization-guided search for temperature-controlled pallet (e.g., perishable pallet) assignments with consideration for splits can be used to book slots for orders for temperature-controlled pallets. In a number of embodiments, orders that can be handled using greedy algorithms can be smaller orders (e.g., less than half of the floor spots of a trailer) in which the routes for delivering the orders can be determined using conventional greedy algorithms. In some embodiments, booking remaining pallets in a trailer can be performed as described below in connection with route optimization and load building 502 (FIG. 5).

In some embodiments, the utilization guided search heuristic for non-temperature-controlled pallet assignments with consideration of splits can be expressed as follows:

Activity 1.0: Estimate a maximum number of deliveries for each dry order that can be based on a number of passive splits and a number of active split constraints applicable to the dry order.

Activity 2.0: Assign each non-temperature pallet to a dry pallet queue associated with a route plan subject to the split constraints.

Activity 2.1. Loop booking slots iteratively until no split violation exists by booking slots for each non-temperature pallet using a ratio of costs/spots as follows:

Activity 2.1.1 When a booking slot is subject to split violations for a physical store on the route plan, select two potential routes with the lowest number of stacks of orders for the physical store.

Activity 2.1.2 Combine all the stacks for the physical store in the two potential routes into a new combined order.

Activity 2.1.3 Unassign all individual orders (replace multiple individual orders with the new combined order), re-book the booking slot.

Activity 3.0: If a spot utilization <X % (e.g., 80%) for any non-empty routes then:

Activity 3.1.1 Empty the route plan.

Activity 3.1.2 Set orders as un-booked.

Activity 3.1.3 Add those orders back to the dry pallet queue.

Activity 3.1.4 Re-sort the non-temperature pallets based on a preferred delivery sequence for a store in the route plan.

Activity 3.1.5 Remove non-temperature trailer types used in a potential solution route.

Activity 3.1.6 Go back to Activity 2.0 until all non-temperature trailer types being used or iterations are >3.

In some embodiments, when a size of an order is larger than can be fit into a single trailer, then the order can be split as a passive split. In several embodiments, the passive split of the order can be delivered using two or more trailers in order to make a successful delivery on a delivery date. In various embodiments, when the size of an order is less than can be fit into a single trailer, an active split can be performed in order to improve trailer utilization and overall driving distance at the expense of an increased number of deliveries to a store.

In some embodiments, a split violation for a physical store can occur when the number of split orders (e.g., deliveries) to a physical store exceeds the max possible number of deliveries that can be made to that store on a certain date and range of time, which in some cases can be specified by the store. In several embodiments, as one or more solution routes are being built, the solution set can include a set of candidate routes which do not have any orders booked. In some embodiments, a non-empty route can be a route that includes one or more booked orders.

In various embodiments, a route spot utilization can refer to every potential candidate route associated with a type of trailer, where each type of trailer can be limited by a maximum number of floor spots. In some embodiments, a route spot utilization can be mathematically expressed as:
a number of occupied floor spots/max number of floor spots

In various embodiments, the utilization guided search heuristic for temperature-controlled pallet assignments with consideration of equipment type can be expressed as follows:

Activity 1.0: For temp-controlled pallets (e.g., refrigerator trailers) with a number of compartments, such as [≥1, ≥2, ≥3], run steps in Activity 2.0 and Activity 3.0 in X(3) iterations.

Activity 2.0: Book slots for temperature-controlled pallets (e.g., perishable pallets) by:

Activity 2.1.1 Use real costs.

Activity 2.1.2 Avoid generating empty routes for those trailer types currently considered.

Activity 2.1.3 Avoid including routes currently booked.

Activity 3.0: If a spot utilization <X % (e.g., 80%) for any non-empty routes then:

Activity 3.1.1 Empty the route plan.

Activity 3.1.2 Set orders as un-booked.

Activity 3.1.3 Add those orders back to an order queue.

In many embodiments, orders that can be handled in connection with a route construction 503 (FIG. 5), as described below, can be routes that are larger (e.g., more than half of the floor spots of a trailer), which can benefit, in some cases, from splitting the orders. In several embodiments, route construction 503 (FIG. 5) can receive input orders in the form of stacks and then can proceed to generate a set of routes by allocating orders to routes. In some embodiments, whenever an order is allocated in a potential route, a greedy insertion heuristic can be used to pick the route with the lowest increase in cost as defined by a cost function. In various embodiments, the cost function can takes into account costs associated with a driving distance, a driving time, a number of stops, a number of trailers used, etc. Further details into the route construction heuristic for ocean routes are discussed below in connection with FIG. 5. In several embodiments, an enhanced load feasibility check 506 (FIG. 5), as described below, can be performed for each potential route and/or the solution route.

In several embodiments, in orders delivered via an ocean route, temperature-controlled pallets and non-temperature-controlled pallets can ride together subject to certain business rules and constraints including bulkhead positions and specific compartment positions for non-temperature-controlled pallets. In various embodiments, constructing potential routes can be achieved by mathematically enumerating possible combination of stacks to compartment assignments and then restricting the solution space to the combinations that satisfy all constraints while minimizing costs.

In many embodiments, a route can include a single order, multiple orders, or part of an order. In several embodiments, the routes can split an order across two of the trailers when a quantity of stacks in the order exceeds a floor spot capacity for one of the trailers, such as one of the trailers that has the highest floor spot capacity that is available to the distribution center. For example, if there are 32 floor spots in a trailer, and the number of stacks in an order is 40, the order can be split among two different routes for two different trucks. In several embodiments, the routes, as obtained and/or determined, can include a sequence of delivery for the orders in the load of the trailer that will be used for the route.

In some embodiments, block 440 can include generating potential insertions of each order into each possible position of candidate routes. In various embodiments, generating potential insertions for booking slots can be performed as expressed:
Activity 1.0 The input can include an order and a solution consisting of potential routes (empty, full and partially full). A greedy heuristic can be used by inserting this order into every possible position in every route.
Activity 2.0 For each possible insertion a feasible load plan can include an existing feasible load plan.
Activity. 3.0 The insertion can include obeying all routing constraints, such as, the route can include meeting the store time windows and the route can include obeying DOT constraints.
Activity. 4.0 Among all possible feasible insertions, the one with the lowest increase in solution cost can be chosen.

In several embodiments, block 440 can include evaluating for each of the potential insertions. In some embodiments, evaluating for each of the potential insertions can include determining whether a feasible load plan exists. In various embodiments, evaluating for each of the potential insertions can include determining whether each of the candidate routes satisfies delivery time windows for the physical stores. In a number of embodiments, evaluating for each of the potential insertions can include determining whether each of the candidate routes complies with DOT Hours of Service constraints. In many embodiments, the routes can include a driving schedule generated subject to rest constraints. Rest constraints can be based on legal regulations, company policies, and/or driver specifications, for example. For example, in the United States, the U.S. Department of Transportation (DOT) rules can specify that drivers have 10 hours or rest for every 10 hours of driving. In a number of embodiments, the schedule can be generated based on cumulative driving time and rest time.

In many embodiments, block 440 can include selecting a potential insertion of the selected insertions with a lowest increase in cost among the potential insertions.

In some embodiments, block 440 using the utilization-guided search can be based on a utilization of a number of floor spots available in each of the containers being greater than or equal to a predetermined threshold.

In several embodiments, block 440 of generating the potential routes for non-temperature-controlled pallets can include estimating a maximum number of deliveries to the physical stores for each dry order of the dry orders based on split constraints for each of the physical stores. In many embodiments, block 440 of generating the potential routes for non-temperature-controlled pallets can include assigning the non-temperature-controlled pallets of the dry order from a dry pallet queue to a candidate route subject to the split constraints and based on costs.

In various embodiments, block 440 of generating potential routes for non-temperature-controlled pallets can include evaluating the utilization for the candidate route.

In several embodiments, block 440 of generating the potential routes for temperature-controlled pallets can include assigning the temperature-controlled pallets for each perishable order of the perishable orders based on the multiple compartments of the temperature-controlled containers and costs.

In some embodiments, block 440 of generating the potential routes for temperature-controlled pallets can include evaluating the utilization for the candidate route.

In various embodiments, block 440 of generating the potential routes for temperature-controlled pallets can include post consolidation and solution refinement. In some embodiments, post consolidation can include booking remaining temperature-controlled pallets (e.g., perishable pallets) for every trailer type by booking slots for remaining non-temperature pallets by booking slots for remaining non-temperature pallets by using real costs, avoiding generating empty routes for those trailer types currently considered, and/or avoiding including routes currently booked. In some embodiments, solution refinement can include booking all remaining pallets for every trailer type by booking slots for all remaining pallets by booking slots for all remaining pallets can be determined by using real costs, and/or including all booked routes and all available trailers. For every route, the minimal cost trailer that can be used can be selected based on evaluating all trailers types with lower costs, and/or evaluating trailers without removable bulkheads with lower costs.

In a number of embodiments, method 400 can include a block 450 of determining, from the potential routes, solution routes that are feasible and minimize costs. In several embodiments, determining, from the potential routes, the solutions routes of block 450 can include comparing costs across containers with potential routes.

In some embodiments, minimizing costs can be based on evaluating trailer costs and trailers without removable bulkheads and/or another alternative bulkhead. In various embodiments, alternative bulkheads can refer to container configurations with fixed bulkheads and/or another suitable bulkhead design. In several embodiments, at this stage, the potential solution routes can include one or more routes and one or more corresponding load plans where every route and load plan can be associated with a selected trailer type. In various embodiments, minimizing costs can be evaluated for each route R and each trailer T, as follows:

Activity 1.0 For each route R in the solution, collect the corresponding orders that can make up the load plan for that route.

Activity 2.0 For each possible trailer type T in the route and load plan, an attempt can be made to build a feasible load plan for the collection of orders associated with the route R with the trailer type T.

Activity. 3 If the attempt is successful and the cost associated with the new trailer T can be a lowest cost among other costs, then the trailer can be chosen to be a part of the final solution.

Activity 4.0 For trailer T, for which there exists a counterpart trailer TO, with the same dimensions and costs, but without a removable bulkhead, an attempt can be made to build a feasible load plan with the counterpart trailer TO.

Activity 5.0 If the attempt is successful, then the counterpart trailer TO can be chosen to be part of the final solution route.

In a number of embodiments, method 400 can include a block 460 of outputting solution routes. These solution route results (e.g., final load designs) can then be used, together with the delivery routes to fulfill and/or physically deliver the orders from the distribution centers (e.g., 350 (FIG. 3)) to the physical stores (e.g., 360 (FIG. 3)) using the trailers according to the plans in the solution results and the delivery routes via ocean routes.

Turning ahead in the drawings, FIG. 5 illustrates a flow chart of a method 500 of automatic generation of a route and load plan using non-homogenous equipment via ocean routes, according to an embodiment. Method 500 is merely exemplary and embodiments of the acts, modules, and outputs are not limited to the embodiments presented herein. The acts, modules, and outputs can be employed in many different embodiments or examples not specifically depicted or described herein. In some embodiments, certain elements of method 500 can perform, involve, and/or be generated by involve various procedures, processes, and/or activities. In other embodiments, the procedures, processes, and/or activities can be performed by, and the outputs can be generated by, other suitable elements of method 500. In many embodiments, method 500 can be implemented by load and route design system 300 (FIG. 3).

In many embodiments, method can begin at block 501 of receiving orders and performing initial processing. In some embodiments, performing initial processing can include processing data associated with types of pallets, physical stores, travel distance and time, rules, and/or another suitable type of data point associated with receiving orders. For example, the orders received can include a mix of dry orders and perishable orders for fulfillment (e.g., delivery) to physical stores from a distribution center (e.g., 350 (FIG. 3)). As another example, the orders can be partitioned into the different distribution centers (e.g., 350 (FIG. 3)) to be used to fulfill the orders and generate potential routes, such as generating potential routes block 440 (FIG. 4). As another example, the orders can be split based on the different types of items of each order, similar or identical to splitting orders block 420 (FIG. 4). As another example, the different types of items in the order can be determined in order to determine what categories of items are included in the order. Each of the categories of items can be stacked on either temperature-controlled pallets or non-temperature-controlled pallets. The types of items can include one or more commodity types.

In many embodiments, method 500 additionally can include a block 502 of route optimization and load building. In many embodiments, block 502 can include a block 503 for a route construction and a block 504 for a load designer. In many embodiments, the number of stacks of dry pallets and perishable pallets of the orders associated with physical stores to fill an order can be determined upon completion of block 501 of receiving orders and performing initial processing. In some embodiments, each of these stacks can have a weight, which can be determined based on the weights of the pallets in the stacks. Each order has a destination at physical stores (e.g., 360 (FIG. 3)) via an ocean route.

Block 503 of route construction can determine a route for each trailer to go to deliver the orders. In many cases, a trailer can carry more than one order, such as two order or three orders, so the routes can be designed such that the trailer carries multiple orders to limit total distances traveled and/or total transit time across all the trailers involved in delivering the orders. In a number of embodiments, block 503 can be implemented as shown in FIG. 4. In many embodiments, blocks 503 and 504 are grouped in block 502 because route construction can involve determining an initial load design, the determining stops at physical stores (e.g., 360 (FIG. 3)) on a route can involve determining the orders that will be included in a load that will leave the distribution center (e.g., 350) in a trailer. In some embodiments, the load leaving the distribution center in a trailer can include being transported via an ocean route to an overseas destination. In many embodiments, block 503 of route construction also can consider rest constraints on drivers to allow drivers delivering the trailers to have sufficient rest. For example, such rest constraints on drivers can be similar or identical DOT Hour of Service constraints block 440 (FIG. 4).

In a number of embodiments, block 504 of the load designer can generate initial load designs, which can output solution routes results of block 505 of outputting solution results, and/or can generate potential delivery routes. Initial load designs from load designer can include the orders that will be included in a trailer. The delivery routes can include transport via an ocean route for delivery to physical stores where the physical stores are located in an overseas destination. Upon reaching the overseas destination, the delivery routes can include a schedule of stops for the trailer.

In several embodiments, load designer block 504 also can include completing the load design, which can include a stack distribution and axle adjustment. In many embodiments, completing the load design can involve using the initial load designs, such as those also generated in block 504, and determining how the stacks in the orders will be assigned to floor spots in the trailer in order to satisfy the schedule of stops and weight distribution constraints.

In several embodiments, method 500 can include a block 506 of enhanced load feasibility check, which can be performed for each potential route and/or the solution route. In some embodiments, when potential routes are being constructed, a 3-D load plan of a load corresponding to a potential route can be generated each time an order is added or removed to a potential route. In various embodiments, enhanced load feasibility check 506 can be run to verify whether a feasible load plan can be generated and whether many alternative load plans are possible. In some embodiments, enhanced load feasibility check 506 can pick a potential route with the lowest cost. In several embodiments, a load plan can specify a position of each stack in the trailer in terms of floor spot (row, column) and orientation. In some embodiments, in addition, every trailer can be associated with zero or more bulkheads which when utilized can be a way to partition stacks of different temperatures into different zones. In various embodiments, enhanced load feasibility check 506 also can ensure that the feasible load plan complies with axle weight considerations as well as roadside and curbside balances.

In many embodiments, method 500 also can include block 507 of route feasibility check. In several embodiments, route feasibility check can consider initial load designs, the determining the stops at physical stores (e.g., 360 (FIG. 3)) on a route, orders included in a load that will leave the distribution center (e.g., 350) in a trailer, rest constraints on drivers to allow drivers delivering the trailers to have sufficient rest, and/or another suitable metric of a feasible route.

In a number of embodiments, method 500 also can include block 505 of generating solution routes based on the final load designs. These final load designs can then be used, together with the delivery routes generated in block 503 to fulfill and/or physically deliver the orders from the distribution centers (e.g., 350 (FIG. 3)) to the physical stores (e.g., 360 (FIG. 3)) using the trailers according to the plans in the final load designs and the delivery routes.

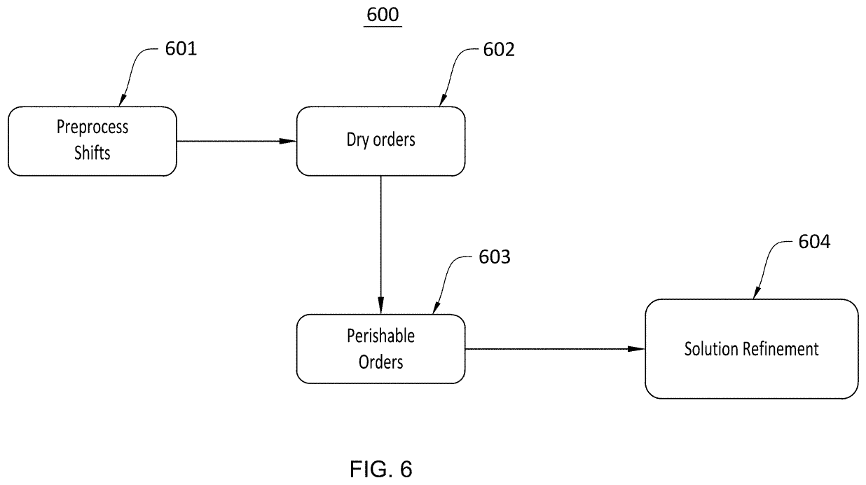

Turning ahead in the drawings, FIG. 6 illustrates a block diagram of a method 600 of automatic generation of a route and load plan using non-homogenous equipment via ocean routes, according to an embodiment. Method 600 is merely exemplary and embodiments of the acts, modules, and outputs are not limited to the embodiments presented herein. The acts, modules, and outputs can be employed in many different embodiments or examples not specifically depicted or described herein. In some embodiments, certain elements of method 600 can perform, involve, and/or be generated by involve various procedures, processes, and/or activities. In other embodiments, the procedures, processes, and/or activities can be performed by, and the outputs can be generated by, other suitable elements of method 600. In many embodiments, method 600 can be implemented by load and route design system 300 (FIG. 3).

In many embodiments, method 600 can begin at block 601 of preprocessing driver shifts. Such driver shifts can be similar or identical to the driver shifts described above in connection with 430 (FIG. 4). In several embodiments, block 601 can preprocess driver shifts in a sequential order based on available insertion space and/or floor space availability in a compartment of the container.

In some embodiments, method 600 also can include a block 602 of booking non-temperature-controlled pallets using utilization-guided search for non-temperature-controlled pallets with consideration of splits, such utilization-guided search can be similar or identical to block 440 (FIG. 4). Booking non-temperature-controlled pallets 602 can be booked first in the non-homogenous equipment selected as part of the solution routes.

In a number of embodiments, method 600 further can include a block 603 of preprocess perishable orders, which can be stacked in temperature-controlled bulkhead sections, spaces, and/or partitions based on available floor space in the temperature-controlled spaces in the trailer. Such temperature-controlled spaces can be similar to those illustrated in FIG. 7, and described below.

In several embodiments, method 600 additionally can include a block 604 of post consolidation and solution refinement to insert types of pallets subject to floor space availability in the temperature-controlled and non-temperature-controlled spaces in the trailer. Such post consolidation and solution refinement processes can be similar or identical to block 450 (FIG. 4) and/or block 503 (FIG. 5).

Turning ahead in the drawings, FIG. 7 illustrates top plan views of a tri-temp trailer 701 with a removable bulkhead and a fixed bulkhead, and a bi-temp trailer 710 with a removable bulkhead. Tri-temp trailer 701 can include various bulkhead compartments, such as compartments 705, 706, and 707, which can be divided using bulkheads, such as removable and/or fixed bulkheads. For example, an adjustable bulkheads can be adjustably positioned along a bulkhead rail 703. Fans 702 and 704 can be used to provide temperature control in the different compartments. Compartments 705-707 can each be a compartment of the tri-temp trailer at the different temperatures. In many embodiments, compartments 705-707 can be configured to transport dry orders and perishable orders, to be delivered at the same or different physical stores (e.g., 360 (FIG. 3)). For example, compartments 705-707 can transport stacks that can be for part or all of an order. In several embodiments, in order to eliminate unloading and reloading of stacks for each order, orders associated with physical stores at the end of a route can be loaded first (at the front of each compartment in the trailer) because these stacks will be delivered at the last stop of the route. Similarly, orders for a physical store located in the middle of the route can be loaded after the orders for the end of the route. Similarly, an order a physical store at the beginning of a route can be loaded last because these stacks will be delivered at the first stop of the route. In a number of embodiments, the number of stacks that can fit in a tri-temp trailer or a bi-temp trailer can be based on the number of floor spots in the trailer, the dimensions (e.g., width, length, height) of the trailer, the number of stacks, and/or the dimensions of the stacks.

For example, compartments 705 and 707 can include temperature-controlled compartments for perishable items, such compartments can be fitted with refrigeration and/or freezer capabilities, such as fan 702 above bulk head compartment 705, and fan 704 above bulk head compartment 707. As another example, removable bulkhead rail 703 can separate the temperature-controlled compartments from the non-temperature-controlled compartment.

In a number of embodiments, bi-temp trailer 710 can include various compartments with different temperature controlled compartments, which can be loaded in two separate compartments 712 and 713 in the trailer, each set for a different temperature. For example, compartment 713 can be a temperature-controlled compartment for perishable items, such compartments can be fitted with refrigeration and/or freezer capabilities, such as a fan 711. Compartment 712 can transport dry orders, and can be separated from compartment 713 by a removable bulkhead.

Returning to FIG. 3, in several embodiments, communication system 301 can at least partially perform block 410 (FIG. 4) of obtaining orders for fulfillment to physical stores from a distribution center.

In several embodiments, order initiation system 302 can at least partially perform block 420 (FIG. 4) of splitting the orders based on a type of each order.

In several embodiments, routing system 303 can at least partially perform block 430 (FIG. 4) of determining containers that are available for driver shifts, block 440 (FIG. 4) of generating potential routes by assigning, using a utilization-guided search, the non-temperature-controlled pallets and the temperature-controlled pallets to compartments of the containers, and/or block 450 (FIG. 4) of determining, from the potential routes, solution routes that are feasible and minimize costs.

In a number of embodiments, load design system 304 can at least partially perform block 460 (FIG. 4) of outputting solution routes.

In some embodiments, the algorithms described can solve for routing and load building problems simultaneously with the objective of minimizing routes, miles traveled, and maximizing trailer utilization particularly for orders including dry orders and perishable orders to be transported via ocean routes for delivery at a destination location, such as Hawaii, Alaska, and/or another port of entry to a country or nation. Further, the techniques described can be used to develop a generic platform integrating pickup/delivery and load design functionality for non-homogenous equipment, such as containers (e.g., trailers) with removable bulkhead and temperature-controlled compartments.

Conventionally, orders from retailers (e.g., physical stores 360 (FIG. 3)) can be configured on types pallets for various commodities with temperature constraints such as items involving refrigeration or a freezer. Generally, available trailers used for delivery can accommodate either temperature-controlled pallets or non-temperature-controlled pallets for transportation, thus a single order with a mix of dry orders and perishable orders can be transported in more than one trailer type for a single delivery date. For example, dry orders and perishable orders ride on separate trailers based on a limited number of trailer types for transport within the 48 states connected by roads. However, deliveries of orders to distribution centers located outside of the 48 states can involve a transportation leg via ocean vessels as an intermediate activity from loading the container to delivery of the orders to the destination location, such as Hawaii, Alaska, and/or another nation or country using transportation via ocean routes. In some embodiments, an advantage of the system can be shown by generating iterations of routing plans and loading plans based on the mix of dry orders and perishable orders loaded into the same trailer type according to a delivery route at the destination location, thus selecting the load design and the route plan with minimal cost, minimal travel time, and within the DOT Hours of Service constraints and other available physical store hours/constraints.

In several embodiments, an advantage of this system can be shown as an improvement over an input problem for a conventional load planning system that does not consider loading a mix of temperature-controlled and non-temperature-controlled pallets. Generally, the input problem of a conventional load planning system can be due a limited number of non-homogenous trailer types used to determine routes and load plans. In some embodiments, there is an additional benefit to identifying the trailer type that can produce a feasible load design that allows temperature and non-temperature controlled pallets to ride together with minimal costs. For example, conventional computer based load planning systems does not support non-homogenous equipment types. Further, the load route generation can be a manual process.

In various embodiments, an advantage can be shown as an improvement over the conventional system as seen in an increased functionality yielding a faster response time to construct routes and loads within less than 1 minute and/or another suitable response period. In some embodiments, another advantage can be shown by providing several iterations of load plans to allow a user to select a cost optimal selection of non-homogenous trailer types among multiple potential solution routes. In several embodiments, providing optimal load designs can result in several advantages, such as, allowing temperature and non-temperature-controlled pallets to ride together subject to business constraints and DOT Hours of Service constraints rules effectively stabilizing loading patterns for transport via ocean vessels and trailers, offering more balance of front and rear axle weights for trailers, offering more balance of curbside and roadside weight balance in the trailers, and minimizing unloading/loading efforts during the trip. For example, each trailer load design accounts for transportation via the ocean vessel without unloading the container. Once the container reaches the port of the destination, the container can be directly picked up by a vehicle for delivery along a route to physical stores and/or distribution centers without unloading the container.

In many embodiments, the techniques described herein can provide a practical application and several technological improvements. In some embodiments, the techniques described herein can provide for automatic generation of load and route designs for non-homogenous equipment via ocean routes using specific inputs and machine-implemented utilization guided searches to determine solution routes for containers that minimize travel distance, cost, and/or time and comply with applicable constraints. These techniques described herein can provide a significant improvement over conventional approaches of designing routes, and/or designing loads using homogenous equipment without considering the breadth of possible options. Further, when considering these aspects collectively, additional improvements can be derived. Moreover, these designs are improvements over other possible approaches, such as subjective estimates and constraint programming.

In many embodiments, the techniques described herein can be used continuously at a scale that cannot be handled using manual techniques. For example, the number of loads from each distribution center transported via ocean routes per day can exceed a hundred or more.

In a number of embodiments, the techniques described herein can solve a technical problem that arises only within the realm of computer networks, as automatically generating potential solution routes do not exist outside the realm of computer networks. Moreover, the techniques described herein can solve a technical problem that cannot be solved outside the context of computer networks. Specifically, the techniques described herein cannot be used outside the context of computer networks, in view of a lack of data, and because the route construction generated for non-homogenous equipment approach cannot be performed without a computer.

Various embodiments include a system. The system can include one or more processors and one or more non-transitory computer-readable media storing computing instructions configured to run on the one or more processors and perform certain acts. The acts can include obtaining orders for fulfillment to physical stores from a distribution center. The orders can be associated with stacks comprising temperature-controlled pallets and non-temperature-controlled pallets. The orders also can include dry orders and perishable orders. The acts also can include splitting the orders based on a type of each order. The acts further can include determining containers that are available for driver shifts. The containers can include temperature-controlled containers each having multiple compartments and dry containers each having a single compartment. The acts additionally can include generating potential routes by assigning, using a utilization-guided search, the non-temperature-controlled pallets and the temperature-controlled pallets to compartments of the containers. The acts also can include determining, from the potential routes, solution routes that are feasible and minimize costs. The acts additionally can include outputting the solution routes.

Several embodiments include a method. The method can be implemented via execution of computing instructions configured to run at one or more processors and stored at one or more non-transitory computer-readable media. The method can include obtaining orders for fulfillment to physical stores from a distribution center. The orders are associated with stacks comprising temperature-controlled pallets and non-temperature-controlled pallets. The orders also can comprise dry orders and perishable orders. The method further can include splitting the orders based on a type of each order. The method additionally can include determining containers that are available for driver shifts. The containers also can include temperature-controlled containers each having multiple compartments and dry containers each having a single compartment. The method also can include generating potential routes by assigning, using a utilization-guided search, the non-temperature-controlled pallets and the temperature-controlled pallets to compartments of the containers. The method additionally can include determining, from the potential routes, solution routes that are feasible and minimize costs. The method further can include outputting the solution routes.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatic generation of load and route designs using non-homogenous equipment via ocean routes has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIGS. 4-6 may include different procedures, processes, and/or activities and be performed by many different modules, in many different orders, and/or one or more of the procedures, processes, or activities of FIGS. 4-6 may include one or more of the procedures, processes, or activities of another different one of FIGS. 4-6. As another example, the systems within load and route design system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to run on the one or more processors and perform:
obtaining orders for fulfillment to physical stores from a distribution center, wherein the orders are associated with stacks comprising temperature-controlled pallets and non-temperature-controlled pallets, and wherein the orders comprise dry orders and perishable orders;
splitting the orders based on a type of each order;
determining containers that are available for driver shifts, wherein the containers comprise temperature-controlled containers each having multiple compartments and dry containers each having a single compartment;
generating potential routes by assigning, using a utilization-guided search, the non-temperature-controlled pallets and the temperature-controlled pallets to compartments of the containers;
determining, from the potential routes, solution routes that are feasible and minimize costs; and
outputting the solution routes.

2. The system of claim 1, wherein splitting the orders based on the type of each order comprises:
splitting the dry orders into a configurable size subject to satisfying one or more order splitting constraints, by:
constructing a first graph of connected components of the dry orders; and
performing a depth first search of the first graph using a traversal algorithm to determine connected components not to split; and
splitting the perishable orders by temperature subject to satisfying the one or more order splitting constraints, by:
constructing a second graph of connected components of the perishable orders; and
performing a depth first search of the second graph using a traversal algorithm to determine connected components not to split.

3. The system of claim 1, wherein splitting the orders based on the type of each order comprises:
sorting the orders for delivery based on the type of the orders and the physical stores to which the orders are associated.

4. The system of claim 3, wherein splitting the orders based on the type of each order further comprises:
setting a max instance to zero for the temperature-controlled container; and
calculating the max instances of the driver shifts using a floor spot capacity estimator by:
determining a maximum number of floor spots for the containers based on pallet dimensions, trailer dimensions, and bulkhead positions; and
setting the max instance to a ratio of a total number of the stacks to the maximum number of floor spots.

5. The system of claim 1, determining the containers that are available for driver shifts comprises:
selecting a temperature-controlled container with a removable bulkhead for a driver shift of the driver shifts, wherein the driver shifts are each associated with a respective type of container; and
selecting an alternative dry container having a cost and physical dimensions that are identical to a cost and physical dimensions of the temperature-controlled container,
wherein:
when a bulkhead of the temperature-controlled container is used in the solution routes, the temperature-controlled container with the removable bulkhead is retained for the driver shift; and
when the bulkhead of the temperature-controlled container is not used in the solution routes, the temperature-controlled container is switched out for the dry container.

6. The system of claim 1, wherein generating the potential routes comprises:
generating potential insertions of each order into each possible position of candidate routes;
evaluating for each of the potential insertions:
whether a feasible load plan exists;
whether each of the candidate routes satisfies delivery time windows for the physical stores; and
whether each of the candidate routes complies with Department of Transportation Hours of Service constraints; and
selecting a potential insertion of the selected insertions with a lowest increase in cost among the potential insertions.

7. The system of claim 1, wherein the utilization-guided search is based on a utilization of a number of floor spots available in each of the containers being greater than or equal to a predetermined threshold.

8. The system of claim 7, wherein generating the potential routes further comprises, for the non-temperature-controlled pallets:
estimating a maximum number of deliveries to the physical stores for each dry order of the dry orders based on split constraints for each of the physical stores;
assigning the non-temperature-controlled pallets of the dry order from a dry pallet queue to a candidate route subject to the split constraints and based on costs;
evaluating the utilization for the candidate route.

9. The system of claim 7, wherein generating the potential routes further comprises, for the temperature-controlled pallets:
assigning the temperature-controlled pallets for each perishable order of the perishable orders based on the multiple compartments of the temperature-controlled containers and costs; and
evaluating the utilization for the candidate route.

10. The system of claim 1, wherein determining, from the potential routes, the solution routes further comprises:
comparing costs across containers with potential routes.

11. A method being implemented via execution of computing instructions configured to run on one or more processors and stored at one or more non-transitory computer-readable media, the method comprising:
obtaining orders for fulfillment to physical stores from a distribution center, wherein the orders are associated with stacks comprising temperature-controlled pallets and non-temperature-controlled pallets, and wherein the orders comprise dry orders and perishable orders;
splitting the orders based on a type of each order;
determining containers that are available for driver shifts, wherein the containers comprise temperature-controlled containers each having multiple compartments and dry containers each having a single compartment;
generating potential routes by assigning, using a utilization-guided search, the non-temperature-controlled pallets and the temperature-controlled pallets to compartments of the containers;
determining, from the potential routes, solution routes that are feasible and minimize costs; and
outputting the solution routes.

12. The method of claim 11, wherein splitting the orders based on the type of each order comprises:
splitting the dry orders into a configurable size subject to satisfying one or more order splitting constraints, by:
constructing a first graph of connected components of the dry orders; and
performing a depth first search of the first graph using a traversal algorithm to determine connected components not to split; and
splitting the perishable orders by temperature subject to satisfying the one or more order splitting constraints, by:
constructing a second graph of connected components of the perishable orders; and
performing a depth first search of the second graph using a traversal algorithm to determine connected components not to split.

13. The method of claim 11, wherein splitting the orders based on the type of each order comprises:
sorting the orders for delivery based on the type of the orders and the physical stores to which the orders are associated.

14. The method of claim 13, wherein splitting the orders based on the type of each order further comprises:
setting a max instance to zero for the temperature-controlled container; and
calculating the max instances of the driver shifts using a floor spot capacity estimator by:
determining a maximum number of floor spots for the containers based on pallet dimensions, trailer dimensions, and bulkhead positions; and
setting the max instance to a ratio of a total number of the stacks to the maximum number of floor spots.

15. The method of claim 11, determining the containers that are available for driver shifts comprises:
selecting a temperature-controlled container with a removable bulkhead for a driver shift of the driver shifts, wherein the driver shifts are each associated with a respective type of container; and
selecting an alternative dry container having a cost and physical dimensions that are identical to a cost and physical dimensions of the temperature-controlled container,
wherein:
when a bulkhead of the temperature-controlled container is used in the solution routes, the temperature-controlled container with the removable bulkhead is retained for the driver shift; and
when the bulkhead of the temperature-controlled container is not used in the solution routes, the temperature-controlled container is switched out for the dry container.

16. The method of claim 11, wherein generating the potential routes comprises:
generating potential insertions of each order into each possible position of candidate routes;
evaluating for each of the potential insertions:
whether a feasible load plan exists;
whether each of the candidate routes satisfies delivery time windows for the physical stores; and
whether each of the candidate routes complies with Department of Transportation Hours of Service constraints; and
selecting a potential insertion of the selected insertions with a lowest increase in cost among the potential insertions.

17. The method of claim 11, wherein the utilization-guided search is based on a utilization of a number of floor spots available in each of the containers being greater than or equal to a predetermined threshold.

18. The method of claim 17, wherein generating the potential routes further comprises, for the non-temperature-controlled pallets:
estimating a maximum number of deliveries to the physical stores for each dry order of the dry orders based on split constraints for each of the physical stores;
assigning the non-temperature-controlled pallets of the dry order from a dry pallet queue to a candidate route subject to the split constraints and based on costs;
evaluating the utilization for the candidate route.

19. The method of claim 17, wherein generating the potential routes further comprises, for the temperature-controlled pallets:
assigning the temperature-controlled pallets for each perishable order of the perishable orders based on the multiple compartments of the temperature-controlled containers and costs; and
evaluating the utilization for the candidate route.

20. The method of claim 11, wherein determining, from the potential routes, the solution routes further comprises:
comparing costs across containers with potential routes.
